(19) United States
(12) Patent Application Publication
(10) Pub. No.: US 2005/0132390 A1
(43) Pub. Date: Jun. 16, 2005

(54) Loading apparatus and information apparatus

(75) Inventors: Koichi Tokumoto, Tokorozawa-Shi (JP); Youichi Konno, Tokorozawa-Shi (JP)

Correspondence Address: YOUNG & THOMPSON, 745 SOUTH 23RD STREET, 2ND FLOOR, ARLINGTON, VA, 22202, US

(73) Assignee: PIONEER CORPORATION, TOKYO (JP)

(21) Appl. No.: 11/008,188

(22) Filed: Dec. 10, 2004

(30) Foreign Application Priority Data
Dec. 10, 2003 (JP) 2003-412084

(51) Int. Cl. G11B 17/04

(52) U.S. Cl. 720/623

(57) ABSTRACT

A loading apparatus is provided with: a roller device capable of abutting on a recording medium from the side of one surface of the recording medium, which is inserted through an insertion slot, and rotating to carry the recording medium in a carrying direction; and at least one arm device which is constructed such that the end portion thereof abuts on one portion of a peripheral portion of the recording medium on the other surface, to press the recording medium onto said roller device from the other surface side, and that a portion including the end portion evacuates from a space to which the recording medium will be carried, by the end portion being moved along the peripheral portion as the recording medium is carried in the carrying direction.

### BACKGROUND OF THE INVENTION

1. Field of the Invention

The present invention relates to a loading apparatus, such as a slot-in type loading apparatus, for loading a recording medium, such as a DVD, a CD (Compact Disc) and a MD (Mini Disc), in an information apparatus for performing at least one of a record operation of recording information and a reproduction operation of reproducing the information with respect to the recording medium.

2. Description of the Related Art

In the information apparatus for performing the record/reproduction operations with respect to a DVD or the like, this type of loading apparatus carries a disc inserted from an insertion slot to a position where the record or reproduction is performed. Such a loading apparatus holds the disc between two rubber rollers placed near the insertion slot, or between the rubber roller and a resin plate, rotates the rubber rollers, and displaces the disc by a friction force caused at that time. Incidentally, the rubber roller and the resin plate are tapered towards the center, not to damage a recording surface of the disc, and hold a peripheral portion of the recording medium.

There are many techniques with respect to such a loading mechanism. For example, Japanese Patent Application Laying Open No. 2002-74800 discloses such a technique that the disc is guided by an out-lever unit for holding the outer edge of the disc near the insertion slot and by a check-plat unit for holding the outer edge of the carried disc in the back of the insertion slot, which are provided in addition to the above-described mechanism, to thereby prevent the deviation of a disc mounting position in carrying the disc.

Moreover, Japanese Patent Application Laying Open No. Hei 11-120657 discloses a disc loading mechanism of carrying a disc by using a hold member, which abuts on the outer circumference of the disc, for holding the disc, in place of the above-described disc loading mechanism in which the surface of the disc directly abuts on the roller.

However, in the method of holding the disc from its both sides by using the rollers or the resin plate, the back surface of the disc (i.e. the surface opposite to the recording surface of the disc) is abraded away by the rollers or the resin plate. The back surface of the disc is a so-called label surface, and there are possibilities that a label comes off by the surface being abraded by the resin plate or the like and that the removed label is stuck inside the apparatus. If the label is to be exchanged, the apparatus is to be checked, or the like, whenever such problems occur, a user cannot use the apparatus at ease.

Moreover, in the technique disclosed in Japanese Patent Application Laying Open No. Hei 11-120657, the disc carriage cannot be started until the disc is fully held, so that the disc is to be inserted deeply into the insertion slot. This may decrease a feeling of quality to the insertion operation.

### SUMMARY OF THE INVENTION

It is therefore an object of the present invention to provide a loading apparatus and an information apparatus capable of giving user-oriented comfortable usability.

The above object of the present invention can be achieved by a loading apparatus for loading a recording medium through an insertion slot to a predetermined inner position for recording or reproducing information. The loading apparatus is provided with: a roller device capable of abutting on the recording medium from a side of one surface of the recording medium, which is inserted through the insertion slot, and rotating to carry the recording medium from the insertion slot to the predetermined inner position; a driving device for driving the roller device to rotate; and at least one first arm device whose end portion abuts on a peripheral portion of the other surface of the recording medium. The end portion of said at least one first arm presses the peripheral portion of said other surface of the recording medium against the roller device to hold the recording medium between the end portion of said at least one first arm and the roller device.

According to the loading apparatus of the present invention, in the loading, the recording medium is inserted into the insertion slot. Then, the roller device abuts on the recording device from the side of one surface (e.g. the side of the top surface which is the recording surface facing the downside). Before or after this, or at the same time, the end portion of the fist arm device abuts on the other surface side of the recording medium (e.g. the side of the back surface which is the label surface facing the upside). With the recording medium held between the roller device and the end portion of the first arm device, if the roller device is driven to rotate by the driving device, the recording medium is carried from the insertion slot to the predetermined inner position by friction between the recording medium and the roller device. Incidentally, the direction in which the recording medium is carried from the insertion slot to the predetermined inner position is referred to as “a carrying direction.” At this time, the end portion of the first arm presses the peripheral portion of the other surface (label surface) of the recording medium, so that force is applied to the recording medium in the downward direction. Therefore, the recording medium is pressed onto the roller device, so that the carriage of the recording medium is well performed by the sufficient friction between the recording medium and the roller device.

In the loading apparatus of the present invention, the end portion of the first arm device applies the downward force to the recording medium, and the peripheral portion of the other surface of the recording medium receives the downward force. By this construction, the whole of the structure for applying the downward force to the recording medium can be placed over the peripheral portion of the other surface (label surface) of the recording medium or at a position away from the recording medium in the radius direction of the recording medium. Concretely, the whole of the first arm device including the end portion, an opposite end portion and an arm member connecting the end portion and the opposite end portion can be placed over the peripheral portion of said other surface of the recording medium or at a position away from the recording medium in the radius direction of the recording medium. Therefore, it is possible to make a space over the other surface of the recording medium. This space spreads over the center portion and a portion between the peripheral portion and the center portion of the other surface of the recording medium. Namely, this space covers the label surface of the recording medium. By making the space over the label surface of the recording medium, it is possible to prevent the label surface of the recording medium from being abraded. Therefore, a label which is stuck, printed, or the like, on the label surface does not come off.

In addition, by adopting this construction, it is possible to place the roller device and the first arm device relatively near the insertion slot. Therefore, all a user needs in the loading is insert the recording medium relatively shallowly, and afterward, an automatic loading operation by the roller device and the first arm device is performed, so that the usability is further improved.

Consequently, it is possible to give the user-oriented comfortable usability.

In one aspect of the loading apparatus of the present invention, a position of the end portion of the first arm device is moved along the peripheral portion as the recording medium is carried from the insertion slot to the predetermined inner position.

According to this aspect, a portion including the end portion of the first arm device is moved and evacuates from a space to which the recording medium will be carried, as the recording medium is carried. Thus, a space is made over the label surface of the recording medium. Therefore, it is possible to prevent the first arm device from abrading the label surface of the recording medium to peel off the label or the like stuck on the label surface.

In one aspect of the loading apparatus of the present invention, there are two of the first arm devices. The roller device is in the shape of a rod. The end portions of said two of the first arm devices are positioned near one end portion and the other end portion of the roller device, respectively. The positions of the end portions of said two of the first arm devices are moved away from each other as the recording medium is carried from the insertion slot to the predetermined inner position.

According to this aspect, the end portions of a pair of the first arm devices abut on two parts of the peripheral portion of the label surface of the recording medium, respectively. As the recording medium is carried from the insertion slot to the predetermined inner position, the pair of the first arm devices open along the shape of the recording medium, and the end portions move away from each other. Thus, even while the recording medium is pressed, the first arm devices evacuate from a space over the label surface (e.g. the back surface facing the upside). Thus, a space is made over the label surface of the recording medium. Therefore, the label which is stuck, printed, or the like, on the label surface does not come off. Moreover, the pair of the first arm devices press the recording medium to the roller device symmetrically from the both sides and hold it, to thereby perform a guide function of inducing the recording medium from the insertion slot to the predetermined inner position and help the recording medium be carried horizontally.

Alternatively, in another aspect of the loading apparatus of the present invention, the loading apparatus further includes a guiding device for holding the recording medium. Moreover, in this aspect, there is one first arm device. The roller device is in a shape of a rod. The end portion of the first arm device is positioned near one end portion of the first arm device. The end portion of the guiding device is positioned near the other end portion of the first arm device. The peripheral portion of the recording medium is held by the end portion of the first arm device and the guiding device when the recording medium is carried from the insertion slot to the predetermined inner position.

According to this aspect, the only one first arm device, which is provided at the position facing near one end of the roller device, holds the recording medium with the roller device and generates a driving force for the carriage. On the other hand, the guiding device, which is provided at the position facing the other end of the roller device, induces and holds another portion of the peripheral portion of the recording medium from the insertion slot to the predetermined inner position. As described above, the cooperation of the first arm device and the guiding device prevents the deviation of the position of the recording medium in carrying.

In another aspect of the loading apparatus of the present invention, the end portion of the first arm device has an abutting surface for pressing the peripheral portion of said other surface of the recording medium against the roller device, and the abutting surface slopes such that the abutting surface abuts on an edge of the peripheral portion of said other surface of the recording medium.

According to this aspect, the abutting surface of the end portion of the first arm device slopes with respect to the label surface of the recording medium, so that the abutting surface abuts on the edge of the peripheral portion of the label surface of the recording medium at a point or on a line. Thus, the end portion of the first arm device can apply the downward force to the recording medium. Therefore, it can press the recording medium to the roller device without contacting and damaging the label surface of the recording medium and without peeling off the label. Moreover, by holding the edge of the recording medium with the oblique abutting surface of the first arm device, it is possible to press the recording medium, even if the insertion position of the recording medium slightly deviates.

In such an aspect that the end portion of the first arm device has the abutting surface, the abutting surface may be curved in a concave shape.

By constituting in this manner, since the abutting surface is curved in the concave shape, it is possible to prevent the peripheral portion of the recording medium from side-slipping on the abutting surface, and it is possible to prevent the deviation of the position of the recording medium.

In another aspect of the loading apparatus of the present invention, the loading apparatus further includes a second arm device. The second arm device is placed on the opposite side of the insertion slot, viewed from the predetermined inner position. The second arm device abuts on the peripheral portion of the recording medium to hold the peripheral portion of the recording medium together with the end portion of the first arm device.

According to this aspect, the peripheral portion of the recording medium in loading is also supported by the second arm device. Thus, the recording medium can be carried with stability on its carriage route. Moreover, the second arm device does not contact the surface of the recording medium as well, so that the damage of the recording medium or the label surface is prevented.

In an aspect provided with the second arm device, the end portion of the second arm device may push the recording medium out such that the recording medium abuts on the roller device, when the recording medium is carried in a direction to the insertion slot from the predetermined inner position.

According to this aspect, in unloading, the end portion of the second arm device is moved from the predetermined inner position side (i.e. the backside of the apparatus) to the insertion slot side (i.e. the front side of the apparatus), while supporting the peripheral portion of the recording medium, by receiving a driving force, for example. By this, the recording medium is pushed out to the insertion slot side, and follows the carriage route backward to thereby abut on the roller device. Afterward, the recording medium is carried by using a thrust or driving force by the roller device, for example. As described above, by using the second arm device, it is possible to carry the recording medium while preventing the damage.

In another aspect of the loading apparatus of the present invention, the loading apparatus further includes: a detecting device for detecting a movement amount of the end portion of said first arm device accompanied by carriage of the recording medium from the insertion slot to the predetermined inner position; and a judging device for judging the size of the recording medium on the basis of the detected movement amount.

According to this aspect, if the external shape of the recording medium is a disc-like or a square-like, for example, and if the movement amount of the end portion of the first arm device along the peripheral portion corresponds to the external size of the recording medium, the detecting device can detect the movement amount, and the judging device can judge or determine the size of the recording medium.

The above object of the present invention can be also achieved by an information apparatus provided with: the above-described loading apparatus; a clamping device for clamping the recording medium, which is loaded by the loading apparatus, without letting the recording medium abut on the roller device and the first arm device; and an information recording or reproducing device capable of performing at least one of information record and information reproduction, with respect to the recording medium clamped by the clamping device.

According to the information apparatus of the present invention, as explained in the loading apparatus of the present invention described above, the roller device and the first arm device operate with them abutting on the recording medium, by which the recording medium is loaded. Therefore, the effects of the operation of the information apparatus in loading are the same as those of the above-described loading apparatus.

Then, when the recording medium is loaded to the predetermined inner position, the roller device and the first arm device detach from the recording medium, and instead, the clamping device clamps the recording medium without letting the recording medium abut on the roller device and the first arm device. Then, with respect to the clamped recording medium, the information recording or reproducing apparatus performs at least one of the information record and the information reproduction.

Incidentally, in association with the various aspects of the loading apparatus of the present invention described above, the information apparatus of the present invention can also adopt various aspects.

The nature, utility, and further features of this invention will be more clearly apparent from the following detailed description with reference to preferred embodiment of the invention when read in conjunction with the accompanying drawings briefly described below.

### BRIEF DESCRIPTION OF THE DRAWINGS

FIG. 1A and FIG. 1B are a plan view and a side view, respectively, showing the structure of a loading apparatus in an embodiment of the present invention;

FIG. 2 is a schematic diagram showing the structures of one end portion and the surrounding portion shown in FIG. 1A and FIG. 1B;

FIG. 3A and FIG. 3B are a plan view and a side view, respectively, showing a condition in carrying a disc on the loading apparatus shown in FIG. 1A and FIG. 1B;

FIG. 4A and FIG. 4B are a plan view and a side view, respectively, for explaining an operation (the 1st step) in loading, on the loading apparatus shown in FIG. 1A and FIG. 1B;

FIG. 5A and FIG. 5B are a plan view and a side view, respectively, for explaining an operation (the 2nd step) in the loading, on the loading apparatus shown in FIG. 1A and FIG. 1B;

FIG. 6A and FIG. 6B are a plan view and a side view, respectively, for explaining an operation (the 3rd step) in the loading, on the loading apparatus shown in FIG. 1A and FIG. 1B;

FIG. 7A and FIG. 7B are a plan view and a side view, respectively, for explaining an operation (the 4th step) in the loading, on the loading apparatus shown in FIG. 1A and FIG. 1B;

FIG. 8A and FIG. 8B are a plan view and a side view, respectively, for explaining an operation (the 1st step) in unloading, on the loading apparatus shown in FIG. 1A and FIG. 1B;

FIG. 9A and FIG. 9B are a plan view and a side view, respectively, for explaining an operation (the 2nd step) in the unloading, on the loading apparatus shown in FIG. 1A and FIG. 1B;

FIG. 10A and FIG. 10B are a plan view and a side view, respectively, for explaining an operation (the 3rd step) in the unloading, on the loading apparatus shown in FIG. 1A and FIG. 1B;

FIG. 11 is a schematic diagram showing a modified example associated with the one end portion shown in FIG. 1A and FIG. 1B;

FIG. 12 is a schematic diagram showing a modified example associated with the one end portion shown in FIG. 1A and FIG. 1B;

FIG. 13 is a schematic diagram showing a modified example associated with structure of the loading apparatus shown in FIG. 1A and FIG. 1B; and

FIG. 14 is a schematic diagram showing the structure of an information apparatus in the embodiment of the present invention.

### DETAILED DESCRIPTION OF THE PREFERRED EMBODIMENT

The embodiment of the present invention will be hereinafter explained with reference to the drawings.

Structure of Apparatus

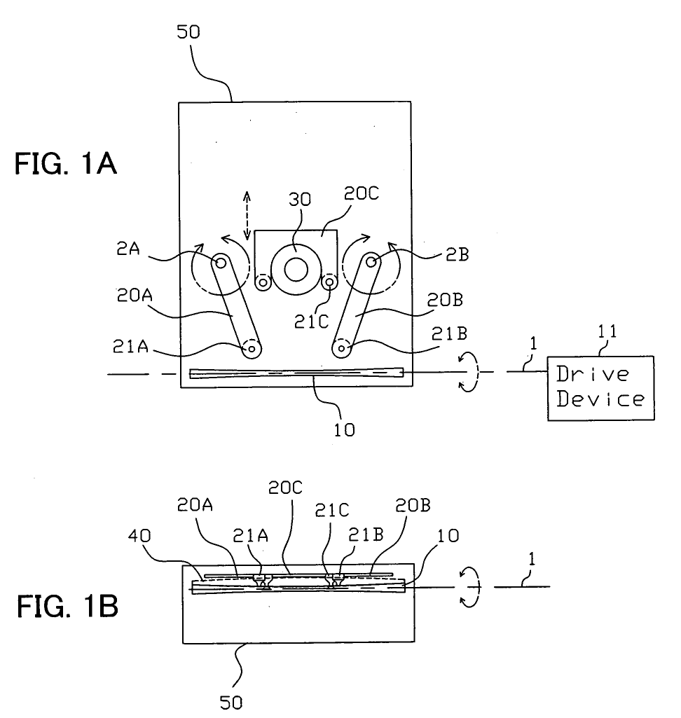

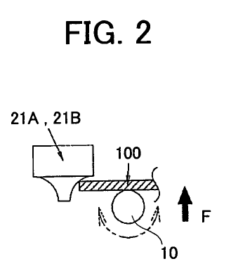

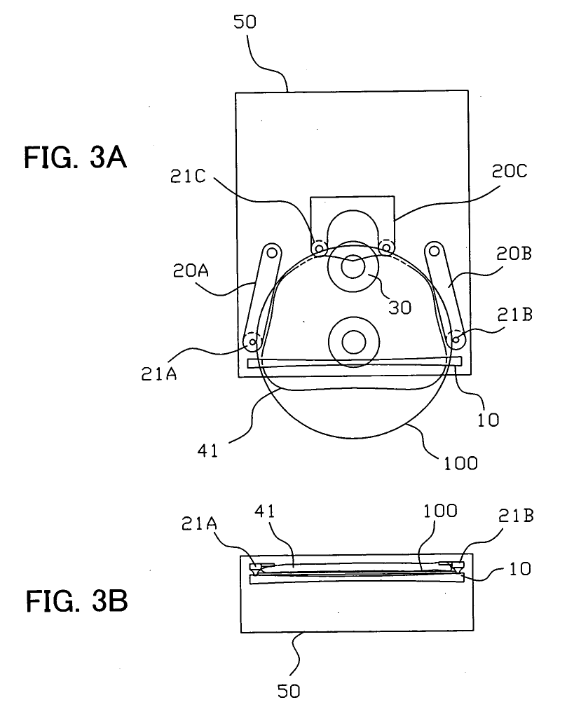

FIG. 1A and FIG. 1B show the structure of a loading apparatus in an embodiment of the present invention, wherein FIG. 1A is a plan view, viewed from the top, and FIG. 1B is a side view, viewed from an insertion slot. FIG. 2 explains a carrier mechanism of the loading apparatus shown in FIG. 1A and FIG. 1B. FIG. 3A and FIG. 3B show that the loading apparatus shown in FIG. 1A and FIG. 1B carries a disc 100, wherein FIG. 3A is a plan view, viewed from the top, and FIG. 3B is a side view, viewed from the insertion slot. Incidentally, this loading apparatus 50 is built in an information apparatus in the embodiment.

In FIG. 1A and FIG. 1B, the loading apparatus 50 is provided with: a roller 10; arms 20A, 20B, and 20C; and a drive device 11 constructed from a motor or the like to rotate the roller 10. The loading apparatus 50 is constructed to carry a disc in a slot-in method. Namely, the loading apparatus 50 performs an operation of pulling in or leading in a disc 100, which is inserted from an insertion slot 40, to a clamp area 30, and an operation of ejecting the disc 100, which is once accommodated in the inside, from the insertion slot 40. In particular, the loading apparatus 50 is constructed to catch and hold the inserted disc 100 with the roller 10 and the arms 20A and 20B, and to carry it by a friction force caused on the roller 10 at that time.

The roller 10 is made of rubber and is in the shape of a rod, for example. It is constructed to abut on one surface of the disc 100 (e.g. a recording surface facing the downside) and rotate around a shaft 1 by a power supplied from the drive device 11 (refer to FIG. 1A and FIG. 1B). The drive device 11 is not necessarily placed directly on one end of the shaft 1, as shown in FIG. 1, and may be placed under the roller 10, for example, by being connected to the shaft 1 via a not-illustrated gear or the like. Moreover, there are tapers towards the center of the cross direction on the surface of the roller 10, to reduce a possibility that the recording surface of the disc 100 (i.e. the downside surface in FIG. 1B) is scratched by contact therewith. By this, the roller 10 contacts the peripheral end portion of the disc 100. The roller 10 of this type is placed near the insertion slot 40, such that the shaft 1 is parallel to the insertion slot 40 and perpendicular to the carrying direction of the disc 100.

The arms 20A and 20B, as one specific example of the first arm device of the present invention, and the arm 20C, are made of resin, for example, and each is constructed to hold the disc 100 between the arm itself and the roller 10. The arms 20A and 20B make a pair. The arms 20A and 20B are supported by shafts 2A and 2B, respectively, and provided at symmetric positions facing near one end and the other end of the roller 10. End portions 21A and 21B abut on the both ends in the cross direction of the disc 100 (refer to FIG. 3A and FIG. 3B) and can rotate around the shafts 2A and 2B, respectively (refer to FIG. 1A and FIG. 1B). Thus, the end portions 21A and 21B operate to move away from each other as the disc 100 is carried. In the embodiment, a force may be applied to the arms 20A and 20B by a not-illustrate elastic member, such as a spring, in a direction of holding the disc 100 between the arms 20A and 20B. Alternatively, a torque may be applied to the shafts 2A and 2B by a not-illustrated elastic member, such as a spring, or an actuator, a motor, or the like, in the direction of holding the disc 100 between the arms 20A and 20B, and by this, a force may be indirectly applied to the arms 20A and 20B.

Incidentally, each of the end portions 21A and 21B has an abutting surface curved in a concave shape, as shown in FIG. 2B, and abuts on one portion of the peripheral portion of the disc 100 on the abutting surface, to thereby function to press the disc 100 from the other surface side (e.g. a label surface facing the upside) onto the roller 10. As the reaction, a force F of pushing the disc 100 out upward acts on the contact portion between the roller 10 and the disc 100, to thereby generate a friction force between the disc 100 and the roller 10. The disc 100 is carried by this friction force.

This prevents the vertical deviation of a disc position in carrying the disc 100. Moreover, a press force received from the roller 10 and the arms 20A and 20B causes a sufficiently large friction force to act on the disc 100, so that quick carriage is possible. In order to show such effects efficiently, the relative relationship is important between an abutting portion of the arms 20A and 20B and an abutting portion of the roller 10, with respect to the disc 100. Namely, the arms 20A and 20b are preferably located as close to the roller 10 as possible. Moreover, in order to generate the force F to an appropriate extent, the distance in the vertical direction between the end portions 21A and 21B and the roller 10 can be adjusted depending on the thickness of the disc 100.

Incidentally, it may be constructed such that the arms 20A and 20B and the roller 10 hold the disc 100 between them with a certain degree of force, to thereby generate the force F of pushing the disc 100 out upward. It is not an issue which of the arms 20A and 20B and the roller 10 can press the disc 100 to the other. Moreover, either or both of the arms 20A and 20B and the roller 10 may be movable in the vertical direction so as to cope with a difference in the thickness of the disc 100, oblique insertion of the disc 100, or the like.

Moreover, here, the movement amount of the end portions 21A and 21B accompanied by the carriage of the disc 100 is detected by a not-illustrated detecting device. From the detection result, it is judged or determined by a not-illustrated controlling device that the insertion or ejection of the disc 100 is started. By transmitting a control signal to the drive device 11, the roller 10 is driven to rotate in the carrying direction.

On the other hand, the arm 20C, as one specific example of the second arm device of the present invention, is constructed to abut on the peripheral portion from its front with respect to the carried disc 100, and move horizontally back and forth (refer to FIG. 1A and FIG. 1B). The arm 20C has one pair of end portions 21C which abut on the disc 100. The end portions 21C are shaped as shown in FIG. 1B and constructed to hold the peripheral portion of the disc 100 from top and bottom. Thus, the disc 100 is supported by the arm 20C when inserted more than to some extent, to thereby prevent the vertical deviation of the disc position.

Moreover, here, the arms 20A, 20B, and 20C abut on the peripheral portion of the disc 100. Furthermore, even other components are placed at a sufficient distance with respect to the top surface of the disc 100 which is inserted. Thus, on the upside (the label surface side) of the disc 100, as shown in FIG. 3, a space 41 is spread substantially as large as the surface of the disc 100. Because of such a construction, although pressed to the roller 10 sufficiently, the disc 100 is carried without contact on the top surface (the label surface). Therefore, it is prevented that the surface is scratched, that a label stuck on the surface comes off, or the like.

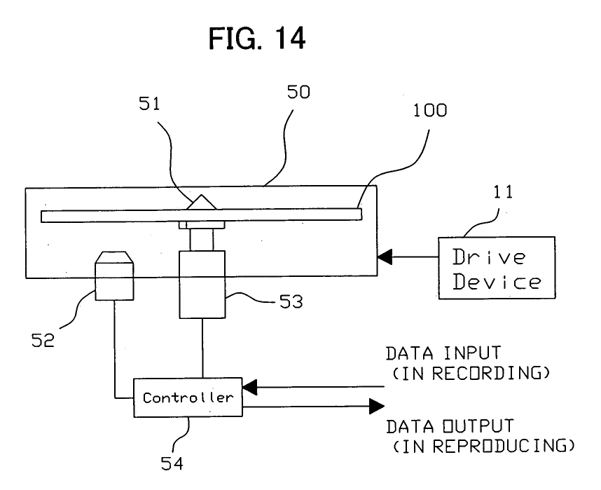

Incidentally, an information apparatus provided with the loading apparatus of this type, for example, as shown in FIG. 14, is further provided with: a clamp 51; an optical pickup 52; a spindle motor 53; and a controller 54. In the information apparatus, the disc 100 loaded by the loading apparatus is clamped by the clamp 51 in the clamp area 30 without abutting on the roller 10 and the arms 20A to 20C. Then, while the disc 100 is driven to rotate by the spindle motor 53, light is irradiated onto the recording surface from the optical pickup 52, to thereby record or reproduce the information. The controller 54 performs an operation control for the optical pickup 52 on the basis of the inputted data to be written, in recording, and performs an operation control to read and output the data on the basis of an output from the optical pickup 52, in reproducing. Incidentally, in the embodiment, the controller 54 is constructed to function even as the controlling device for the loading apparatus 50.

Operation of Apparatus

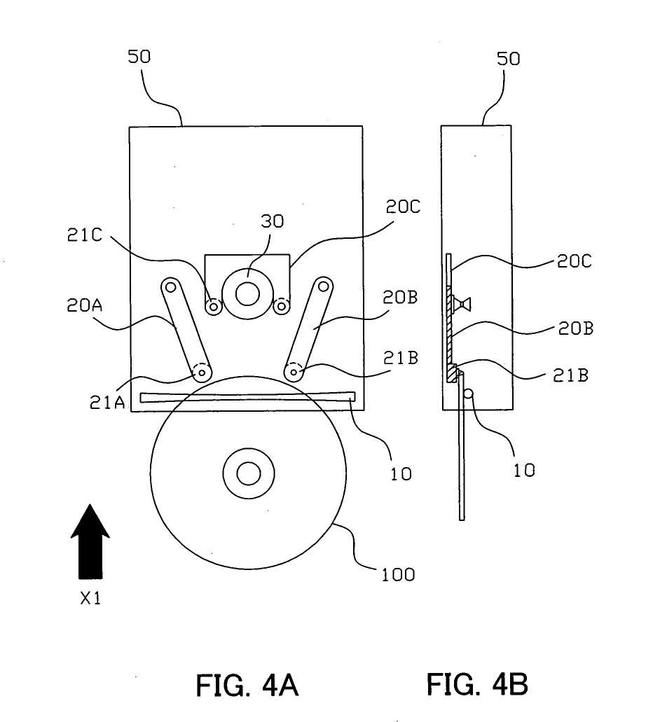

Next, the operation of the loading apparatus will be explained with reference to FIG. 4 to FIG. 10. Incidentally, in each of FIG. 4 to FIG. 10, FIG. A is a plan view of the apparatus, viewed from the top, and FIG. B is a right side view of the apparatus. Incidentally, the left and right in FIG. B correspond to the up and down of the apparatus. Moreover, here, the disc 100 is inserted with the recording surface facing the downside, the label surface facing the upside.

(Loading of Disc 100)

At first, as shown in FIG. 4A and FIG. 4B, the end portion of the disc 100 is inserted to the insertion slot 40. The disc carrying direction is shown with an arrow X1 in FIG. 4A. At this time, in the vicinity of the insertion slot 40, the roller 10 abuts on the disc 100 on the recording surface side. On the other hand, the end portions 21A and 21B of the arms 20A and 20B, respectively, abut on one portion of the end portion of the disc 100 from the label surface side. In this manner, the end portions 21A and 21B hold the disc 100 between them and the roller 10 in contact only with the peripheral portion of the disc 100.

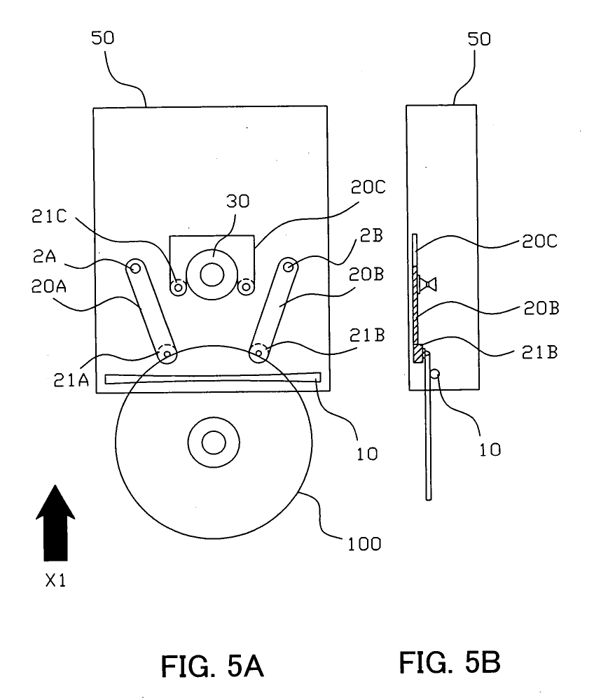

Moreover, if the disc 100 is inserted to some extent, as shown in FIG. 5A and FIG. 5B, the arms 20A and 20B open, with the shafts 2A and 2B as the center, such that portions including the end portions 21A and 21B evacuate from a space to which the disc 100 will be carried. At this time, the end portions 21A and 21B are moved to spread out along the peripheral portion of the disc 100, away from each other.

As described above, if the end portions 21A and 21B are moved, the roller 10 starts rotating. Namely, the movement amount of the end portions 21A and 21B is detected by the not-illustrated detecting device. The controlling device (not-illustrated), which judges the insertion of the disc 100 from the detection result, drives the drive device 11, to thereby rotate the roller 10. Incidentally, in order to detect the movement amount of the end portions 21A and 21B, for example, a method of detecting the rotation amount of the arms 20A and 20B by rotational torque measurement or the like, a method of providing a switch for detecting the passage of the arms 20A and 20B on the movement route thereof, and the like are used. As the method of detecting the insertion of the disc 100, in addition to the above methods, a method of detecting the vertical operation of the arms 20A and 20B and the roller 10 by the detecting device, which uses the vertical movement property thereof in holding the disc 100 between them, and the like are listed. This is the same even as in stopping the roller in the ejection of the disc described later.

The disc 100 is in such a condition that it is pressed to the roller 10 by the end portions 21A and 21B. Thus, the sufficiently large friction force acts on the contact surface between the disc 100 and the roller 10 in accordance with the press force. Namely, as soon as the roller 10 receives a driving force and starts rotating, the inserted end of the disc 100 is pulled into the apparatus by the friction force, and the disc 100 is carried in the carrying direction X1.

As described above, the disc 100 is quickly pulled into the apparatus only as the inserted end slightly contacts the roller 10. A user does not have to insert the disc 100 into the back of the apparatus, for example, and the comfortable use is allowed.

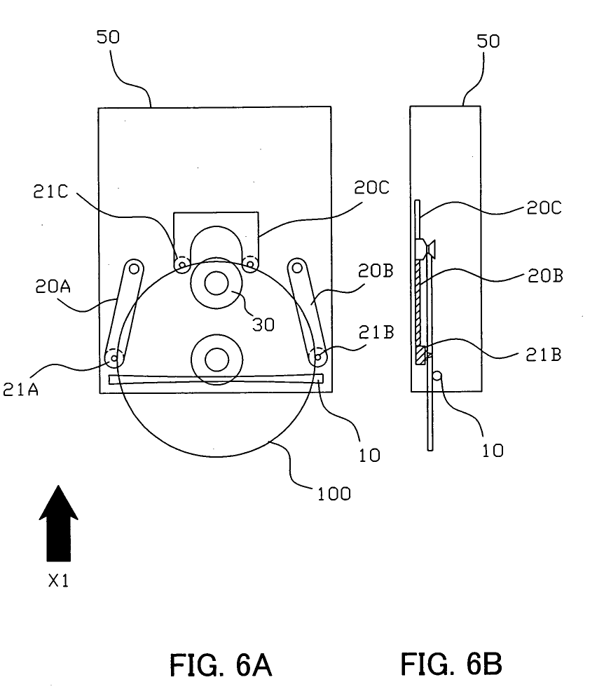

Then, as shown in FIG. 6A and FIG. 6B, the roller 10 rotates while the end portions 21A and 21B and the roller 10 hold the disc 100 between them in the vertical direction, to further send the disc 100 in the carrying direction X1. The end portions 21A and 21B are moved in conjunction with the disc 100, and press the disc 100 to the roller 10 symmetrically from the both sides and hold it, to thereby perform a guide function of inducing the disc 100 in the carrying direction X1 and help the disc 100 be carried horizontally.

In this manner, if the disc 100 is carried to the back of the apparatus, the arm 20C abuts on the disc 100. The arm 20C is moved in the carrying direction X1, with the movement of the disc 100, while holding the inserted end of the disc 100. If the arm 20C does not exist, there is a possibility that the disc 100 loses its horizontal balance as the disc 100 is carried, because the inserted end moves away from fulcrums by the roller 10 and the arms 20a and 20B. However, the inserted end is supported by the arm 20C, as described above, so that the disc 100 is carried with stability and horizontally.

In the above-described series of operations, the disc 100 is held between the roller 10 and the arms 20A and 20B, which are intended to catch and hold the disc outer circumference, however, in the vicinity of the label surface which is the top surface, there is not any component contactable with the disc 100, and the space 41 is spread sufficiently (refer to FIG. 3A and FIG. 3B). Thus, there is nothing in contact with the label surface of the disc 10, so that it is possible to prevent a label from coming off from the label surface and being damaged during the carriage. Alternatively, even if a label starts to peel a little and is almost coming off, it is possible to prevent the portion from sticking to the components inside of the apparatus, or the like.

If there are the possibilities that a label comes off, that the removed label is stuck inside the apparatus, or the like, and moreover, if the label is to be exchanged, the apparatus is to be checked, or the like, whenever such problems occur, a user cannot use the apparatus at ease. Furthermore, recently, a CD-R and the like in which the label surface can be printed, have been released and there are now many discs with original labels, and such labels are usually valuable. From these reasons, the prevention of the label damage in loading is an issue associated with the reliability of the apparatus, and it is extremely important.

Incidentally, during the carriage operation, the end portions 21A and 21B maintain the constant relative positions between them and the roller 110 in connection with the position of the disc 100 in the insertion slot 40. Thus, the disc 100 is held with the constant press force and carried by the constant friction force.

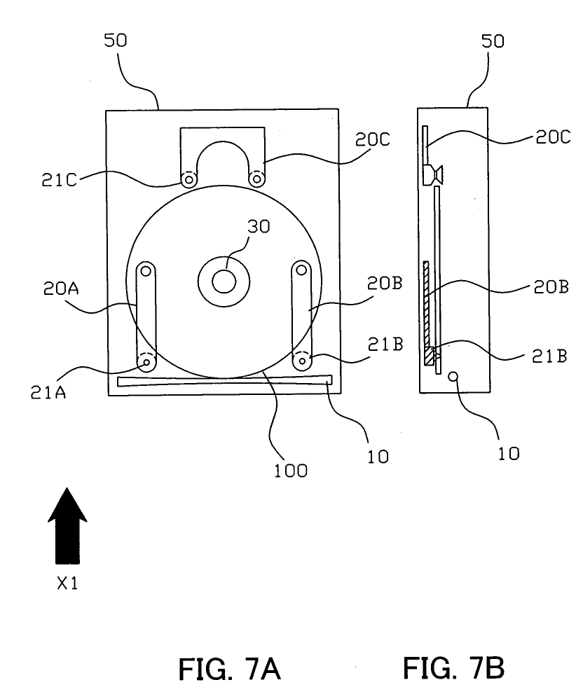

Then, as shown in FIG. 7A and FIG. 7B, the center of the disc 100 reaches to the clamp area 30, and the disc 100 is clamped by a clamping device. In conjunction with this operation, the arms 20A, 20B, and 20C evacuate from the disc 100 and are locked, and the roller 10 also evacuates therefrom and is stopped. In this manner, it is prevented that the components used for the carriage contact the disc 100 in the rotation of the disc 100.

Then, the disc 100 is driven to rotate in the clamp area 30, and the information is recorded or reproduced by an information recording or reproducing device.

(Unloading of Disc 100)

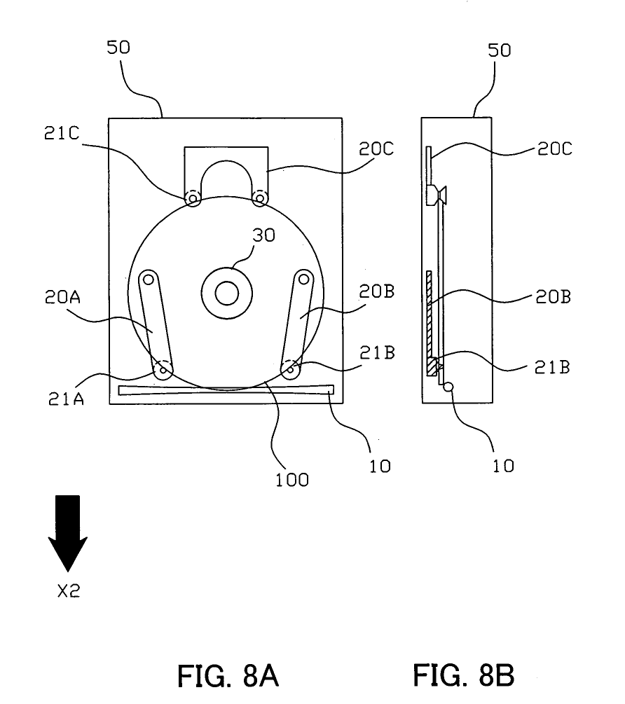

Then, for example, on the basis of a “disc ejection” command outputted from the outside or the like, the rotation of the disc 100 is stopped. Then, as shown in FIG. 8A and FIG. 8B, the arm 20C is driven and moved in a carrying direction X2, to thereby push the disc 100 out. At the same time, the disc 100 is lifted again to a position where the roller 10 contacts the recording surface of the disc 100, and the roller 10 starts rotating. Moreover, the lock of the arms 20A and 20B is also released, and contacts the peripheral portion of the disc 100. As the disc 100 is pushed out by the arm 20C, each of the end portions 21A and 21B is moved along the peripheral portion of the disc 100, and each of the arms 20A and 20B starts turning as the center of each of the shafts 2A and 2B.

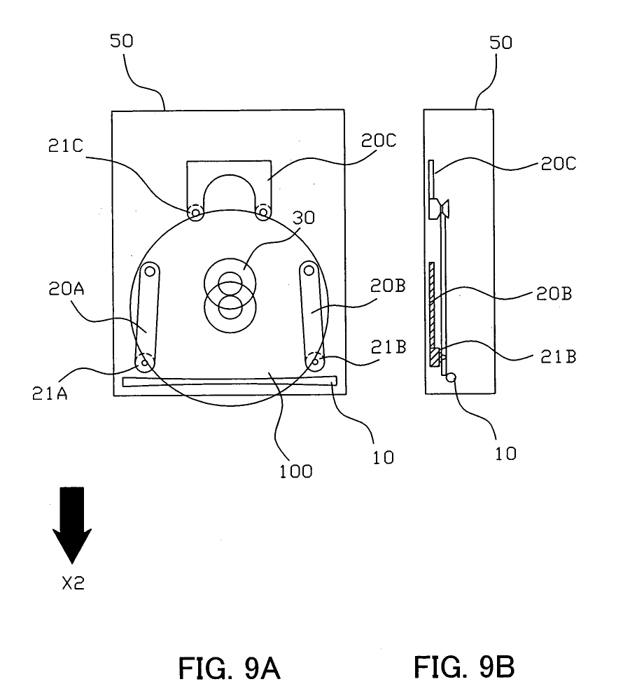

If the disc 100 is pushed out to some extent, as shown in FIG. 9A and FIG. 9B, the disc 100 is completely held between the roller 10 and the arms 20A and 20B. After that time point, the disc 100 is carried by the rotation of the roller 10. At this time, even the arm 20C holds the disc 100, balances it horizontally, and carries it.

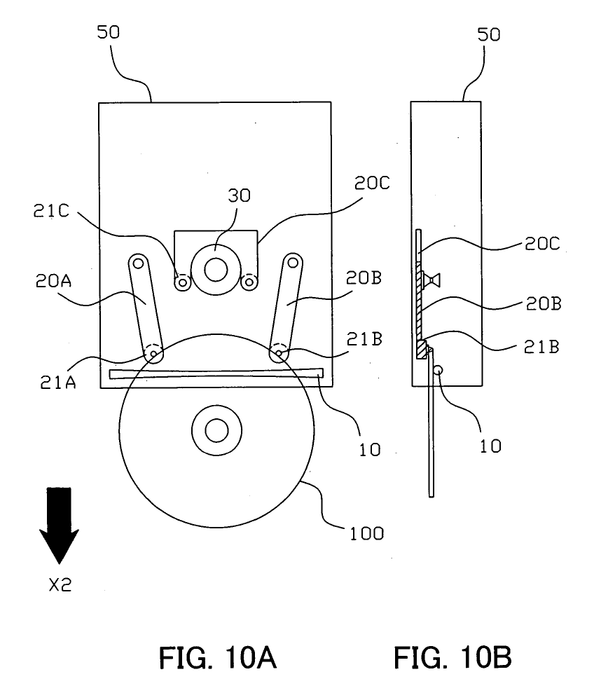

At last, as shown in FIG. 10A and FIG. 10B, the rotation of the roller 10 is stopped, and the ejection of the disc 100 is completed with the disc 100 held between the roller 10 and the arms 20A and 20B. Incidentally, the rotation of the roller 10 is stopped by detecting the movement amount of the end portions 21A and 21B by the detecting device, judging the progress of the ejection by the controlling device on the basis of the detected amount, and stopping the drive device 11.

In the embodiment, as described above, the disc 100 is pressed to the roller 10 by using the arms 20A and 20B, so that benefits in this roller method can be used as they are. Namely, it is possible to make the start of loading (pulling-in the disc) quick. Thus, it is possible to provide a good feeling of quality of the loading and a comfortable usage environment for a user.

Moreover, the arms 20A and 20B are constructed such that they abut on the peripheral portion of the carried disc 100 and that portions including the end portions 21A and 21B evacuate from a space to which the disc 100 will be carried as the disc 100 is carried, so that the sufficient space 41 is secured on the upside (i.e. on the label surface side) of the disc 100. Therefore, it is possible to prevent the damage and removal of a label, to thereby increase the reliability of the apparatus.

Incidentally, in a conventional loading apparatus which uses a friction force to pull-in the disc, it is necessary to provide a guide mechanism, in addition to a roller and a resin plate which hold a disc between them, to ensure its stable operation. On the contrary, in the loading apparatus in the present invention, the arms 20A and 20B have both the function of holding the disc 100 and the guide function, so that the number of components can be reduced and the above-described effects can be realized by a simple apparatus structure.

### MODIFIED EXAMPLES

The specific structure of the loading apparatus in the present invention is not limited to the above-described example, and can be variously modified. Some of the modified examples will be exemplified.

### Modified Example 1

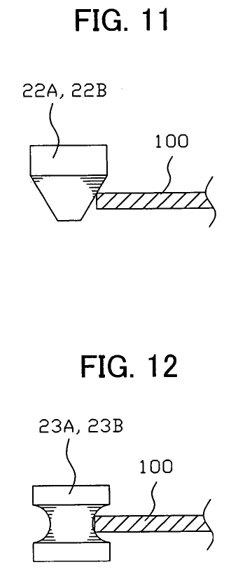

The above-described example adopts the end portions 21A and 21B as shown in FIG. 2A and FIG. 2B, but the end portions of the arms may have such a structure as shown in FIG. 11 and FIG. 12, for example.

End portions 22A and 22B shown in FIG. 11 has a not-curved abutting surface. Even in this case, the abutting surface can press the peripheral portion of the disc 100 downward.

End portions 23A and 23B associated with the modified example in FIG. 12 are constructed to hold one portion of the peripheral portion of the disc 100 between two portions of each abutting surface. Thus, the position of the disc 100 in carrying is regulated in the vertical direction, to thereby prevent the vertical deviation of the position of the disc 100. Moreover, the end portions 23A and 23B cannot catch and hold the disc 100 if the disc 100 is inserted in an oblique direction, for example, so that they function to prevent the oblique insertion of the disc.

### Modified Example 2

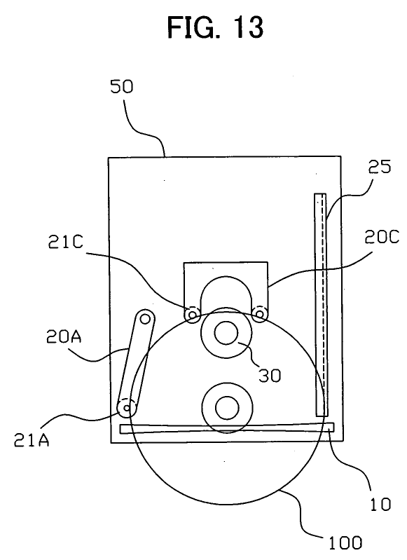

Moreover, as shown in FIG. 13, only the arm 20A may be provided, and a guide 25 may be provided in place of the arm 20B. The guide 25 is intended to induce the disc 100 in the disc carrying direction X1 or X2. Such a guide 25 is a rail-like structure extending in the carrying direction, with a groove for catching and holding one portion of the peripheral portion of the disc 100, for example. In this case, the disc 100 is held between the arm 20A and the roller 10, and carried by a friction force generated by the holding. At that time, the disc 100 is held by the arm 20A and the guide 25, on the both left and right side, and the disc position in the horizontal direction is regulated.

Moreover, in the above-described embodiment, the movement amount of the end portions 21A and 21B is detected by the detecting device, and on the basis of the detected movement amount, the roller 10 is driven. However, a judging device for judging or determining the size of the disc 100 on the basis of the movement amount may be provided. Namely, the movement amount of the end portions 21A and 21B which are moved along the peripheral portion of the disc 100 corresponds to the external size of the disc 100. Thus, if it is constructed such that the judging device judges the size of the disc 100 on the basis of the movement amount, it is possible to judge the size of the disc 100 at each time of the disc carriage, for example. Therefore, for example, it is possible to change a control amount of the abutting positions of the end portions 21A and 21B with respect to the disc 100 or the like, and control the subsequent carriage operation, depending on the size of the disc 100.

Furthermore, in the above-described embodiment, the roller 10 abuts on the recording surface of the disc 100, and the end portions 21A and 21B abut on the peripheral portion of the disc 100 from the label surface side. On the contrary, the roller 10 may abut on the label surface, and the end portions of the arms may abut on the peripheral portion on the recording surface. This is preferable if it is undesired that the recording surface is scratched by dust or the like when the disc 100 is abraded by the roller 10 and if the damage of the recording surface is a more serious problem than the removal and scratch of the label. Incidentally, in the above-described embodiment, it is explained that the roller 10 is placed on the downside, and that the arms 20A and 20B are placed on the upside, but these up-down positions may be opposite. Alternatively, it is also possible that the apparatus is set upright and that the roller device and the arm device hold the recording medium between them from the left and right. Moreover, it may be constructed such that the arm device is supported by a shaft, as in the arms 20A and 20B in the embodiment, to perform a rotational operation, and in addition, that the arm device can perform a slide operation. Furthermore, one or two arm devices may be provided, as occasion demands, at a position or positions other than the position explained with the specific example. Alternatively, more than two arm devices may be provided.

Incidentally, it has been explained that a circular-plate-like disc 100 is treated, but the recording medium in the present invention is not limited to a DVD, a CD, and the like which have a disk-shaped external shape, but also includes what is kept in a protective case in a plate-like external shape, such as a MD and a Flexible Disk (FD). Namely, the present invention is also applied to a loading apparatus of a slot-in type, targeted to a recording medium whose external shape is a plate-like, as well as an information apparatus provided with such a loading apparatus, and also shows the above-described effects of the operation. Incidentally, in the case of the recording medium whose planar shape is a square as described above, the arm device which performs the slide operation is more preferable, because of its smooth operation, than the one which is supported by a shaft to perform the rotational operation.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2003-412084 filed on Dec. 10, 2003 including the specification, claims, drawings and summary is incorporated herein by reference in its entirety.

1. A loading apparatus for loading a recording medium through an insertion slot to a predetermined inner position for recording or reproducing information,
the loading apparatus comprising:
a roller device capable of abutting on the recording medium from a side of one surface of the recording medium, which is inserted through the insertion slot, and rotating to carry the recording medium from the insertion slot to the predetermined inner position;
a driving device for driving the roller device to rotate; and
at least one first arm device whose end portion abuts on a peripheral portion of the other surface of the recording medium,
wherein the end portion of said at least one first arm presses the peripheral portion of said other surface of the recording medium against the roller device to hold the recording medium between the end portion of said at least one first arm and the roller device.

2. The loading apparatus according to claim 1, wherein a position of the end portion of the first arm device is moved along the peripheral portion of the recording medium, as the recording medium is carried from the insertion slot to the predetermined inner position.

3. The loading apparatus according to claim 1, wherein there are two of the first arm devices, the roller device is in the shape of a rod, the end portions of said two of the first arm devices are positioned near one end portion and the other end portion of the roller device respectively, and the positions of the end portions of said two of the first arm devices are moved away from each other as the recording medium is carried from the insertion slot to the predetermined inner position.

4. The loading apparatus according to claim 1, further comprising: a guiding device for holding the recording medium,
wherein there is one first arm device, the roller device is in a shape of a rod, the end portion of the first arm device is positioned near one end portion of the first arm device, the end portion of the guiding device is positioned near the other end portion of the first arm device, and the peripheral portion of the recording medium is held by the end portion of the first arm device and the guiding device when the recording medium is carried from the insertion slot to the predetermined inner position.

5. The loading apparatus according to claim 1, wherein the end portion of the first arm device has an abutting surface for pressing the peripheral portion of said other surface of the recording medium against the roller device, and the abutting surface slopes such that the abutting surface abuts on an edge of the peripheral portion of said other surface of the recording medium.

6. The loading apparatus according to claim 5, wherein the abutting surface is curved in a concave shape.

7. The loading apparatus according to claim 1, further comprising a second arm device which is placed on an opposite side of the insertion slot, viewed from the predetermined inner position,
wherein the second arm device abuts on the peripheral portion of the recording medium to hold the peripheral portion of the recording medium together with the end portion of the first arm device.

8. The loading apparatus according to claim 7, wherein the end portion of said second arm device pushes the recording medium out such that the recording medium abuts on said roller device, when the recording medium is carried in a direction to the insertion slot from the predetermined inner position.

9. The loading apparatus according to claim 1, further comprising:
a detecting device for detecting a movement amount of the end portion of said first arm device accompanied by carriage of the recording medium from the insertion slot to the predetermined inner position; and
a judging device for judging the size of the recording medium on the basis of the detected movement amount.

10. The loading apparatus according to claim 1, wherein the whole of the first arm device including the end portion, an opposite end portion and an arm member connecting the end portion and the opposite end portion is positioned over the peripheral portion of said other surface of the recording medium or at a position away from the recording medium in a radius direction of the recording medium, and a space spreads over the center portion and a portion between the peripheral portion and the center portion of said other surface of the recording medium.

11. The loading apparatus according to claim 10, wherein the space covers a label surface of the recording medium.

12. An information apparatus comprising:
a loading apparatus for loading a recording medium through an insertion slot to a predetermined inner position for recording or reproducing information, the loading apparatus comprising: a roller device capable of abutting on the recording medium from a side of one surface of the recording medium, which is inserted through the insertion slot, and rotating to carry the recording medium from the insertion slot to the predetermined inner position; a driving device for driving the roller device to rotate; and at least one first arm device whose end portion abuts on a peripheral portion of the other surface of the recording medium and presses the peripheral portion of said other surface of the recording medium against the roller device to hold the recording medium between the end portion of said at least one first arm and the roller device;
a clamping device for clamping the recording medium, which is loaded by the loading apparatus; and
an information recording or reproducing device capable of performing at least one of information record and information reproduction, with respect to the recording medium clamped by the clamping device.
